(19) United States
(12) Patent Application Publication
(10) Pub. No.: US 2006/0089905 A1
(43) Pub. Date: Apr. 27, 2006

(54) Credit and identity protection network

(76) Inventors: Yuh-shen Song, Northridge, CA (US); Catherine Lew, Northridge, CA (US); Alexander Song, Northridge, CA (US); Victoria Song, Northridge, CA (US)

Correspondence Address: FULBRIGHT AND JAWORSKI LLP, 555 S. FLOWER STREET, 41ST FLOOR, LOS ANGELES, CA, 90071, US

(21) Appl. No.: 11/036,931

(22) Filed: Jan. 14, 2005

Related U.S. Application Data
(60) Provisional application No. 60/621,928, filed on Oct. 26, 2004.

(51) Int. Cl. G06Q 40/00

(52) U.S. Cl. 705/39

(57) ABSTRACT

A computer network, Credit and Identity Protection Network (“CIPN”), is established to detect credit damage and identity theft occurring to individuals, organizations, and other entities. It automatically advises the potential victims to verify the possible fraudulent activities and helps them to take proper actions to protect their credit and identity. In addition, this computer network provides the potential victim with assistance in notifying financial institutions, credit bureaus, merchants, and government agencies of suspicious activities and/or of confirmed fraudulent cases so that these organizations can take proper actions to protect themselves and the victims.

This application claims priority of U.S. provisional patent application No. 60/621,928 filed on Oct. 26, 2004, which is hereby incorporated in this application.

### FIELD OF INVENTION

The present invention relates generally to maintenance of accurate financial transaction records and associated identity information, and financial crimes prevention. More specifically, the present invention uses computer networks and modern information technologies to prevent credit damage and identity theft and protect victims, merchants, financial institutions, and government agencies against losses and damages caused by identity theft and fraudulent activities.

### BACKGROUND OF THE INVENTION

Identity theft has become one of the most common but damaging financial crimes in the past few years. An experienced con artist can easily steal hundreds of thousands of dollars from a victim, whose identity has been stolen. Although a victim can be eventually proven to be innocent after a lengthy investigation, the victim's life or business may be totally ruined during the process of the investigation.

It is very easy to steal an identity. The easiest way is to steal the credit cards, checks, or other financial instruments from a victim's mailbox, which is seldom locked. After e-commerce becomes popular, many new approaches, such as phishing, are used to steal a victim's identity through modern technology.

In addition to using fancy technology, the oldest method of stealing also works. In May of 2004, America Online (also known as aol.com) disclosed that one of its former employees had stolen the account information of its 21 million customers from American Online's customer database and had sold it to a third party. No fancy technology was required in that case.

Since an identity can be easily stolen, it is very likely that any entity may become a victim of identity theft. A victim of identity theft usually does not know that his/her/its identity has been stolen. When a victim eventually becomes aware of the situation, he/she/it may have already carried a huge amount of debt or liabilities under his/her/its title, and the con artist may have already run away.

We are living in a society where credit rating is extremely important to us. In addition to the direct damage resulting from identity theft and other fraudulent activities, a person or an organization can be easily hurt by unintentional mistakes in communications or procedures that were made without the victim's knowledge. Under any circumstance, the victim deserves a chance to clear his/her/its bad credit record that is caused by mistakes or fraud.

At this time, some credit bureaus or third parties are offering services, which monitor the credit status of a person or an organization. If there is any change in the credit status, the person or the organization will be informed of such change so that the person or the organization has the chance to take protective actions if it is a case of fraud.

These services require an individual or an organization to physically subscribe to these services and pay expensive on-going fees to monitor the credit status of the person or the organization.

In reality, although credit damage or identity theft can happen to any person or any organization at any time, it seldom occurs to the same entity repeatedly. Furthermore, even though credit damage or identity theft can cause inconvenience to the victims, these victims seldom take a large amount of losses at the end of the investigation because the consumer protection law has protected them against these losses, and their financial institutions or the involved merchants may have to eventually swallow these losses. As a result, it is difficult for an individual or an organization to justify the expensive payments for on-going monitoring services provided by these credit bureaus or third parties.

Besides, credit bureaus and their agents can only see a partial picture of all the fraudulent activities. For example, a con artist can use the stolen checks to cheat small retail stores by using very low-dollar-amount transactions. It is very likely that such fraudulent activities will never be reported to credit bureaus.

In this document, the terminology “network” or “networks” generally refers to a communication network or networks, which can be wireless or wired, private or public, or a combination of them, and includes the well-known Internet.

In this document, the terminology “computer system” generally refers to either one computer or a group of computers, which may work alone or work together to reach the purposes of the system.

In this document, a “bank” or “financial institution” is generally referred to as a financial service provider, either a bank or a non-bank, where financial services are provided.

In this document, a “bank account” or “financial account” is generally referred to as an account in a financial institution, either a bank or a non-bank, where financial transactions are conducted through payment instruments such as cash, checks, credit cards, debit cards, electronic fund transfers, etc.

In this document, a “credit check” or “background check” is generally referred to as a check of the credit history or the background of a person, an organization, or any other entity. A credit check or background check is usually required during an application process where a good credit or background is crucial to the approval of the application.

In this document, a “credit bureau” or “background check company” is generally referred to as an organization, which keeps the credit history of individuals or organizations in a database. Through commercial arrangements, a third party can log into this database to examine the background and credit history of any person or organization so that a decision can be made about this person or the organization based on the credit history or background of this person of organization. For example, in the USA, Experian, Equifax, TransUnion, etc. are generally referred to as credit bureaus.

### SUMMARY OF THE INVENTION

The present invention intends to reach the important purpose of credit and identity protection through an innovate approach based on modern computer and network technologies. Instead of consumers, the financial institutions that usually swallow the ultimate financial losses of identity theft and other organizations will take the proactive role for credit and identity protection of their customers, members, employees, etc. through the present invention. Furthermore, since the on-going cost of monitoring is shared among all individuals, organizations and other entities, it becomes affordable and practical for any individual, organization, or other entity to use this Credit and Identity Protection Network (“CIPN”).

One objective of the present invention is to provide an early warning message to potential victims, whose identity may have been stolen and used by con artists or whose credit may have been damaged by fraud or mistakes. Another objective is to protect the victims, financial institutions, merchants, or other organizations, which could suffer loses and damages as a result of the fraud or identity theft.

Con artists can commit many different kinds of fraud based on a stolen identity. For example, a con artist can simply use stolen or counterfeit checks to purchase goods or services by using a fake driver's license, which can be obtained from black market. Therefore, merchants are able to provide relevant information about possible fraud or identity theft cases.

Financial institutions are often at the frontlines, encountering all fraudulent financial transactions. For example, a con artist can use a fake identity to cash a counterfeit check and disappear. A con artist can use stolen credit card or debit card to purchase goods or services. Very often, a con artist uses a stolen identity to apply for new financial accounts. Once the financial accounts are opened successfully based on the stolen identity, the con artist will try to quickly borrow money from the financial institutions and disappear without paying back the borrowed money. For these reasons and many other reasons, financial institutions can frequently provide substantial information about suspected fraud or identity theft cases.

The law requires a financial institution to verify the background of an applicant first before opening a new account. This standard procedure often includes a credit check or background check through one of the popular credit bureaus or their third-party agents, which provide similar services. Furthermore, many merchants such as car dealers will perform credit checks before providing financing to the customers. As a result, credit bureaus and their agents can also provide relevant information about possible fraud or identity theft cases.

According to one aspect of the present invention, a computer system and network (“Credit and Identity Protection Network”) automatically collects the information about credit check activities from credit bureaus such as Equifax, Experian, D&B, etc. and their third-party agents.

According to another aspect of the present invention, a computer system and network automatically collects credit application information when a credit applicant submits such information for credit approval.

In yet another aspect of the present invention, a computer system and network collects information reported by merchants, who have suffered losses as a result of fraud or identity theft.

Similarly, in still another aspect of the present invention, a computer system collects information reported by financial institutions or other organizations, which have suffered losses as a result of fraud or identity theft.

By analyzing the collected information, the computer system can compile a list of “Possible Victims” (“PV”). The list of PV is sent to participating financial institutions or other organizations. A computer system inside a participating financial institution or other organization will compare the received PV list with its customer database, member database, employee database, or other relationship databases. If a match is found among the individuals and other entities with whom the financial institution has an established relationship, the financial institution or other organization will warn the matched entity of a possible credit fraud or identity theft by phone, fax, e-mail or other appropriate communication method.

After receiving the warning message from his/her/its financial institution or other organization, a matched entity can log into the computer system of the Credit and Identity Protection Network to obtain more specific information about the reported activities which triggered that warning. Alternatively, in another embodiment the matched entity can also directly contact the service center of the Credit and Identity Protection Network for such additional information.

If a matched entity concludes that there is nothing fraudulent about the credit check activities or the reports by merchants, financial institutions or other organizations that triggered the warning, the potential victim can simply dismiss the warning, and then, everything goes back to normal.

If, however, the matched entity concludes that his/her/its credit check activities or the reports by merchants, financial institutions, or other organizations are the result of fraudulent activities, he/she/it can inform the Credit and Identity Protection Network of the confirmed fraudulent activities.

Once the victim has verified the fraudulent activities, the Credit and Identity Protection Network informs all participating financial institutions or other organizations of such a confirmed case of identity theft or fraud. These financial institutions or other organizations can take immediate steps to protect themselves and their customers against possible losses or damages as a result of this or other related fraudulent activity.

The Credit and identity Protection Network can inform the participating merchants, which can then employ extra caution to protect themselves.

The Credit and Identity Protection Network can also act on behalf of the victim to instruct the credit bureaus to place the victim's credit information under special status whereby the victim has to specifically authorize any release of information each time a credit check request is made by a third party.

The Credit and Identity Protection Center can also inform the police departments or other government agencies so that they can take proper actions to handle these cases and prevent further losses or damage.

### BRIEF DESCRIPTION OF THE FIGURES

FIG. 1 illustrates the system and network diagram of Credit and Identity Protection Network (“CIPN”), which protects individuals, organizations, or other entities against credit damage and identity theft.

FIG. 2 (comprising FIG. 2A and FIG. 2B) is a set of flow charts indicating how the system shown in FIG. 1 performs credit and identity protection.

### DETAILED DESCRIPTION OF CERTAIN PREFERRED EMBODIMENTS AND COMBINATIONS OF EMBODIMENTS

The present invention will in practice be used with certain other inventions, including those which are invented by the same group of inventors, and potentially includes a number of embodiments to provide maximum flexibility so that all the related inventions will cooperate to achieve enhanced credit and fraud prevention. Accordingly, we will describe in detail only a few exemplary presently preferred embodiments of the present invention and certain exemplary combinations of those embodiments.

After stealing an identity, a con artist often uses the stolen identity to purchase goods and services from retail stores.

In addition, a con artist often uses the stolen identity to quickly obtain cash or cash equivalents through loans, credit cards, etc. and will disappear before the victim notices that his/her/its credit has been ruined.

In order to obtain cash or cash equivalents in advance, a con artist has to go through credit checks based on the stolen identity. There are only a limited number of credit bureaus in the whole world, which can check the credit of an individual, organization, or other entities. These credit bureaus also sell information to a limited number of agents, which provide similar services. Therefore, it is not difficult to collect the information about credit check activities through commercial arrangements with these organizations.

In one embodiment of the present invention, a computer network, Credit and Identity Protection Network (“CIPN”), automatically collects information about fraud and credit check activities. Once such information is collected from credit bureaus and their agents, the computer system of CIPN can analyze these credit check activities to identify suspicious fraudulent and identity theft activities.

For example, a credit applicant with a high frequency of credit checks within a very short period of time is suspicious. A credit applicant with different addresses shown on different credit applications is also suspicious. Two different applicants with the same driver license number are suspicious. A person with a credit rating that has suddenly dropped very quickly is suspicious. In addition, those skilled in the art will know of many other possible types of suspicious activities.

In another embodiment of the present invention, the CIPN computer automatically collects information from credit applicants when they submit credit applications. This can be accomplished by, for example, establishing a communication mechanism between the credit application software packages and CIPN through commercial arrangements with the vendors, which provide these software packages.

In other embodiments of the present invention, the CIPN computer automatically collects fraud information from merchants, including retail stores, from financial institutions, and/or from involved government agencies.

After the analyses of collected fraudulent and identity theft activities, in one embodiment of the present invention, the computer system of CIPN compiles a list of Possible Victims (“PV”) and sends this PV list to participating financial institutions or other organizations. These financial institutions or other organizations will check this list with their own customer database, member database, employee database or other databases. If a match is found, the matched customer, member, employee, etc. can be a possible victim of identity theft or credit damage.

In one embodiment of the presentation, the financial institution or other organization should send a warning message to the matched customer, member, employee, etc. through e-mail. In other embodiments of the presentation, the financial institution or other organization should send a warning message to the matched customer, member, employee, etc. through fax.

In an alternative embodiment of the presentation, the financial institution or other organization should send a warning message to the matched customer, member, employee, etc. through phone.

In another alternative embodiment of the presentation, the financial institution or other organization should send a warning message to the matched customer, member, employee, etc. through other communication methods.

CIPN or its agents can also directly sign on members or customers. In one embodiment of the present invention, the CIPN computer can also compares the PV list with its own member database, customer database, employee database or other databases or its agents' member database, customer database, employee database, or other databases. If a match is found, CIPN should inform the matched member, customer, employee, etc. of possible identity theft or credit damage.

Similarly, in one embodiment of the presentation, CIPN should send a warning message to the matched member, customer, employee, etc. through e-mail.

In another embodiment of the presentation, CIPN should send a warning message to the matched member, customer, employee, etc. through fax.

In an alternative embodiment of the presentation, CIPN should send a warning message to the matched member, customer, employee, etc. through phone.

In another alternative embodiment of the presentation, CIPN should send a warning message to the matched member, customer, employee, etc. through other communication methods.

After receiving the warning message sent by CIPN, the financial institution, or other organization, in one embodiment of the present invention, a potential victim should log into the computer system of CIPN and study whether the suspicious activities detected by CIPN are true activities of the potential victim, or fraudulent activities of con artists.

In another embodiment of the present invention, a potential victim should call the service center of CIPN and discuss whether the suspicious activities detected by CIPN are true activities of the potential victim, or fraudulent activities of con artists.

In an alternative embodiment of the present invention, a potential victim can go to a service center of CIPN and discuss in person whether the suspicious activities detected by CIPN are true activities of the potential victim, or fraudulent activities of con artists.

In another alternative embodiment of the present invention, a potential victim can go to a service center of CIPN where a self-service terminal is available for the potential victim to study whether the suspicious activities detected by CIPN are true activities of the potential victim, or fraudulent activities of con artists.

If the detected activities are normal to the potential victim, the warning status in CIPN is dismissed.

If the detected activities are fraudulent, the potential victim should report this case to credit bureaus, government agencies, police departments, or other organizations, and/or obtain help from legal counsels or other entities.

In one embodiment of the present invention, CIPN automatically inform credit bureaus, government agencies, police departments, etc. of such a fraudulent or identity theft case.

In another embodiment of the present invention, CIPN provides links for the victim to connect to credit bureaus, government agencies, police departments, etc. so that the victim can take proper actions to protect his/her identity.

In an alternative embodiment of the present invention, CIPN provides information to the victim so that the victim can use the information as guideline to take proper actions.

In another alternative embodiment of the present invention, CIPN provides links to third parties, such as law firms so that the victim can obtain the necessary help.

Once the victim has confirmed the fraudulent or identity theft cases, CIPN can inform participating financial institutions or other organizations so that these organizations can take proper actions to protect themselves and the victim against further losses or damages.

In addition, CIPN can analyze these confirmed cases to identify trends, patterns and other statistical information, which can be used to prevent future fraud or identity theft.

CIPN can also use the confirmed cases to detect similar cases so that other potential victims can be quickly identified. As a result, these potential victims can take immediate steps to protect themselves.

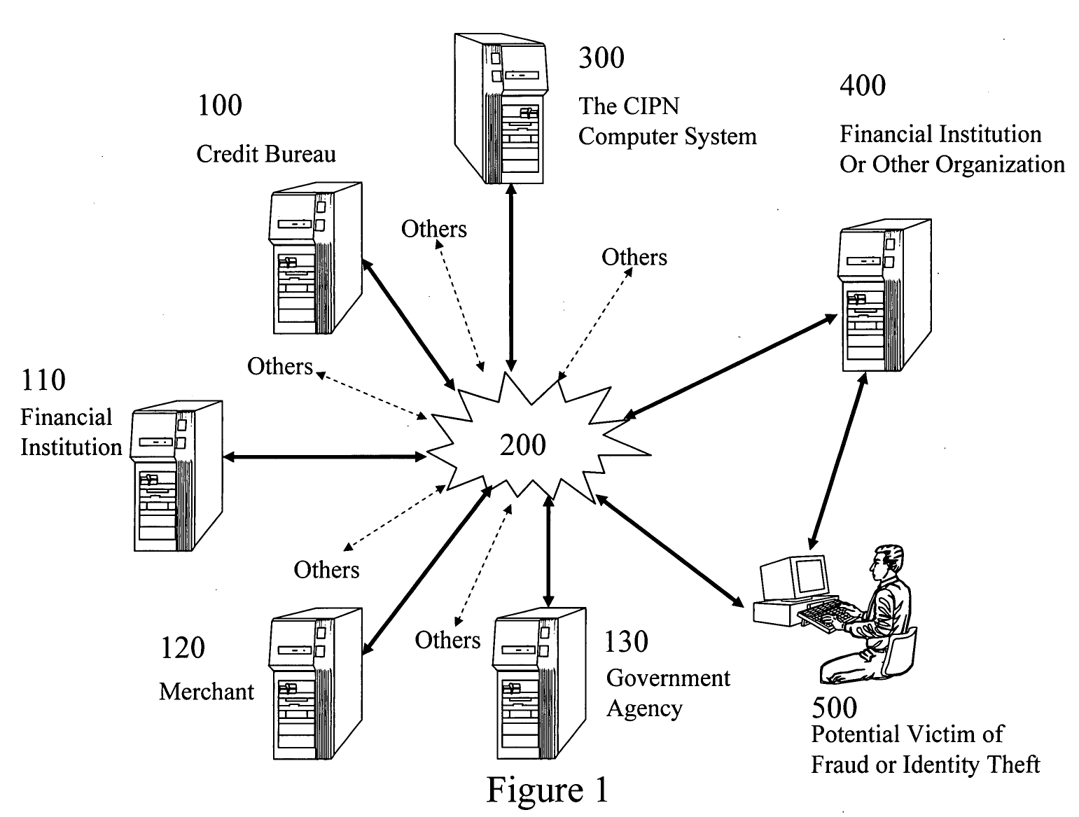

As contemplated in the described embodiments, one of the possible combinations of the preferred embodiments is given below as an example. The computer system of Credit and Identity Protection Network 300 protects the customer 500 of a financial institution or other organization 400 against fraud, credit damage, and identity theft as shown in FIG. 1.

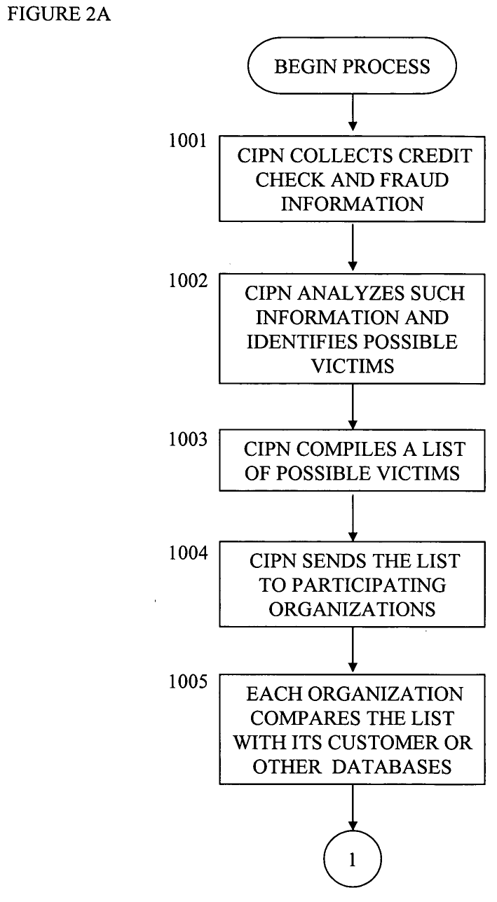

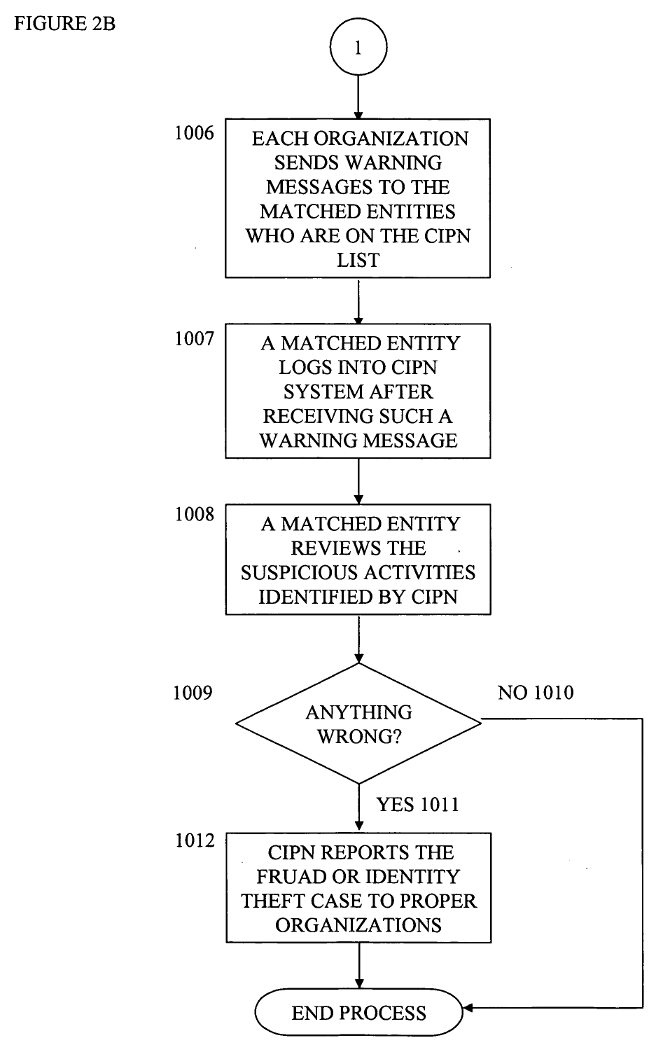

References should now be made to the flowchart of FIG. 2 in combination with the system diagram of FIG. 1, which together illustrate how the system protect individuals, organizations, or other entities against credit damage and identity theft.

First (block 1001), the computer system of Credit and Identity Protection Network (“CIPN”) 300 collects details about credit check and fraud report activities from credit bureau 100, financial institution 110, merchant 120, government agency 130, and other analogous organizations (not shown) via a secure computerized information network 200, which may operate over a known public communications network such as the Internet utilizing known secure protocols such as IPSec over IP.

Next (block 1002), the computer system of CIPN 300 analyzes the collected credit check and fraud report activities to identify any apparent identity theft victims associated with the reported fraud activities and also possible identity theft victims of other suspicious activities which have not yet been reported as possibly fraudulent. For example, a high frequency of credit checks within a very short period of time often occurs after a con artist has stolen an identity and quickly applied for loans, credit cards, and etc. based on that stolen identity. A credit application by a person with an address different from what is in the record may be a possible case of identity theft. A credit application by a person with a different driver license numbers is suspicious, too. Those skilled in the art will recognize other analogous patterns that can also be used to identify suspicious activities and possible victims.

Then (block 1003), the computer system of CIPN 300 complies a list of Possible Victims (“PV”), who are associated with the suspicious activities based on the information about credit check and fraud report activities collected from credit bureaus, financial institutions, merchants, government agencies, etc. These are possible victims of credit damage and identity theft.

After compiling a list of PV (block 1004), the computer system of CIPN 300 sends the list of PV to financial institutions or other organizations, which have participated in this credit and identity protection program, via network 200.

Upon receiving the list of PV (block 1005), a financial institution or other organization 400 compares this PV list with its own customer database, member database, employee database, or other databases and identifies any entities who/which are on the list and which have not already been notified of the suspicious activity and have not already confirmed that their identity has been stolen.

Once the entities that match the PV list are identified (block 1006), a financial institution or other organization 400 sends a warning message to each of these matched entities. This warning message can be sent via e-mail, fax, phone or other communication methods.

After receiving the warning message from CIPN (block 1007), a matched entity 500, who is a possible victim of credit damage or identity theft, can log into the computer system of CIPN 300 via a network 200. If a computer network access is not available, a matched entity 500 can contact the CIPN service center instead.

After logging into the CIPN computer system 300 (block 1008), the matched entity 500 should review all of his/her/its activities, which are identified by the CIPN computer 300 as suspicious.

If the matched entity advises the CIPN computer system 300 that there is nothing wrong (NO branch 1010 from the decision block 1009), the “suspicious” warning status in CIPN is cancelled.

If there is something wrong (YES branch 1011 from the decision block 1009), the matched entity 500 is advised to report a case of possible identity theft or fraud to the proper organizations, such as credit bureaus, government agencies, police departments, etc. (block 1012), preferably using a report form automatically generated by CIPN computer 300. In the meantime until the report has been officially verified by the responsible organization, the activities remain identified as “suspicious” or “under investigation”.

In addition, once the possible victim has had an opportunity to confirm whether the suspicious activities are authentic or fraudulent, CIPN can inform participating financial institutions or other organizations even before any official report is filed, so that these organizations can take appropriate actions to protect themselves and the victim against further losses or damages.

Those skilled in the art will doubtless recognize that the described embodiments can be assembled in various ways to form a variety of applications based on the need, and that obvious alterations and changes in the described structure may be practiced without meaningfully departing from the principles, spirit and scope of this invention. Accordingly, such alterations and changes should not be construed as substantial deviations from the present invention as set forth in the appended claims.

1. A computerized method for using a networked computer system to maintain accurate credit and identity data associated with individuals, organizations, or other entities affiliated with participating organizations, comprising:
collecting financial transaction information over a computer network, said information including details of requests for credit checks, reported credit denials, and any available reports of suspected fraudulent transactions;
performing a computer analysis on the collected information to detect possibly fraudulent activities;
compiling a computer generated list of possible victims of the detected possibly fraudulent activities;
sending the compiled list of possible victims over the computer network to at least some of the participating organizations;
comparing the list of possible victims with a respective database maintained by each of the recipient participating organizations to match and identify any potential victim with respective contact information maintained by the recipient participating organization;
using said contact information to thereby inform said matched potential victim as to the detected activities;
requesting the matched potential victim to verify whether any of the suspicious activities involved in said potential case are accurate; and
taking appropriate action based on the potential victim's response.

2. The method of claim 1 wherein said appropriate action includes:
if all the suspicious activities are verified as authentic by the potential victim, dismissing the case.

3. The method of claim 1 wherein said appropriate action includes:
if any of the suspicious activities are identified by the potential victim as inaccurate, assisting the potential victim to make appropriate notification to the source of the erroneous information.

4. The method of claim 1 further comprising:
performing a further computer analysis to determine whether the detected suspicious activities related to a particular matched individual are consistent with a potential case of identity theft to the matched individual;;
informing said matched potential victim as to the detected activities that are so determined to be consistent with said potential case; and
if the potential victim verifies said potential case of identity theft, providing computerized assistance to the potential victim for limiting further use of the stolen identity.

5. The method of claim 1 wherein:
said collecting of information is accomplished at least in part through computerized information provided by at least credit bureaus.

6. The method of claim 1 wherein:
said collecting of information is at least in part accomplished indirectly through communication with agents of credit bureaus, which provide services by using the data from credit bureaus.

7. The method of claim 1 wherein:
said collecting of information is accomplished through at least the applicants, who may need to go through credit checks, to get some kind of approval.

8. The method of claim 1 further comprising: if the potential victim confirms that the detected cases are fraudulent activities conducted by third parties, advising the victim to take proper actions to prevent losses and damages.

9. The method of claim 1 wherein:
said collecting of information is accomplished through at least merchants.

10. The method of claim 9 wherein:
the merchants are at least retail stores.

11. The method of claim 1 wherein:
said collecting of information is accomplished through at least financial institutions.

12. The method of claim 1 wherein:
said collecting of information is accomplished through at least government agencies.

13. The method of claim 1 wherein:
at least one participating organization compares the list of possible victims with its member database.

14. The method of claim 13 wherein:
the participating organization is at least a financial institution.

15. The method of claim 1 wherein:
at least one participating organization compares the list of possible victims with its customer database.

16. The method of claim 15 wherein:
the participating organization is a financial institution.

17. The method of claim 1 wherein:
at least one participating organization compares the list of possible victims with its employee database.

18. The method of claim 17 wherein:
the participating organization is at least a financial institution.

19. The method of claim 1 wherein:
the list of possible victims is at least compared with a private database, which is established based on members of an organization that has the right to use this computerized method.

20. The method of claim 1 further comprising:
the list of possible victims is at least compared with a private database, which is established based on customers of an organization that has the right to use this computerized method.

21. The method of claim 1 further comprising:
the list of possible victims is at least compared with a private database, which is established based on employees of an organization that has the right to use this computerized method.

22. The method of claim 1 wherein:
informing the potential victim is accomplished at least through e-mail.

23. The method of claim 1 wherein:
informing the potential victim is accomplished at least through fax.

24. The method of claim 1 wherein:
informing the potential victim is accomplished at least through phone.

25. The method of claim 1 wherein:
a potential victim is given permission to log into the computer system through a public network to verify the cases detected by the computer system.

26. The method of claim 1 wherein:
a potential victim calls a service center to verify the cases detected by the computer system.

27. The method of claim 1 wherein:
a potential victim visits a service center in person to discuss and verify the cases detected by the computer system.

28. The method of claim 1 wherein:
a potential victim uses a self-service terminal to verify the cases detected by the computer system.

29. The method of claim 1 wherein:
once the potential victim has verified that the detected case is fraudulent, the computer system automatically reports the case to credit bureaus.

30. The method of claim 1 wherein:
once the potential victim has verified that the detected case is fraudulent, the computer system automatically reports the case to police departments.

31. The method of claim 1 wherein:
once the potential victim has verified that the detected case is fraudulent, the computer system automatically reports the case to government agencies.

32. The method of claim 1 wherein:
once the potential victim has verified that the detected case is fraudulent, the computer system automatically connects the victim to a credit bureau computer.

33. The method of claim 1 wherein:
once the potential victim has determined that the detected case is fraudulent, the computer system automatically connects the victim to a police department computer.

34. The method of claim 1 wherein:
once the potential victim has determined that the detected case is fraudulent, the computer system automatically connects the victim to a government agency computer.

35. The method of claim 1 wherein:
once the potential victim has determined that the detected case is fraudulent, the computer system automatically displays action guidelines to the victim.

36. The method of claim 1 wherein:
once the potential victim has determined that the detected case is fraudulent, the computer system automatically provides the victim with a network link to a third party for further help.

37. The method of claim 36 wherein:
the third party is a non-profit organization.

38. The method of claim 36 wherein:
the third party is a commercial service provider.

39. The method of claim 36 wherein:
the third party is a law firm.

40. The method of claim 1 wherein:
once the potential victim has determined that the detected case is fraudulent, the computer system will at least report the case to financial institutions.

41. The method of claim 1 wherein:
once the potential victim has determined that the detected case is fraudulent, the computer system automatically reports the case to merchants.

42. The method of claim 41 wherein:
at least some of the merchants are retail stores.

43. The method of claim 1, further comprising:
once the potential victim has verified that the detected cases are fraudulent, performing an analysis to detect related potential cases involving other potentially fraudulent activities and other potential victims.

44. The method of claim 43, further comprising:
using the verified cases of fraudulent activities to identify trends, patterns or other statistical information.

45. A computerized method for using a networked computer system to maintain accurate credit and identity data associated with individuals, organizations, or other entities affiliated with participating organizations, comprising:
collecting financial transaction information over a computer network, said information including details of requests for credit checks, reported credit denials, and any available reports of suspected fraudulent transactions;
performing a computer analysis on the collected information to detect possibly fraudulent activities;
compiling a computer generated list of possible victims of the detected possibly fraudulent activities;
sending the compiled list of possible victims over the computer network to at least some of the participating organizations;
comparing the list of possible victims with a respective database maintained by each of the recipient participating organizations to match and identify any potential victim with respective contact information maintained by the recipient participating organization;
using said contact information to thereby inform said matched potential victim as to the detected activities;
requesting the matched potential victim to verify whether any of the suspicious activities involved in said potential case are accurate; and
taking appropriate action based on the potential victim's response.
performing a further computer analysis to determine whether the detected suspicious activities related to a particular matched individual are consistent with a potential case of identity theft to the matched individual;
informing said matched potential victim as to any detected activities that are so determined to be consistent with said potential case; and
if the potential victim verifies said potential case of identity theft, providing computerized assistance to the potential victim for limiting further use of the stolen identity. wherein
said appropriate action includes if all the suspicious activities are verified as authentic by the potential victim, dismissing the case and if any of the suspicious activities are identified by the potential victim as inaccurate, assisting the potential victim to make appropriate notification to the source of the erroneous information. and if the detected cases are fraudulent activities conducted by third parties, helping the victim take proper actions to prevent losses and damages, and reporting the cases to participating organizations, which can take proper actions to prevent losses and damages that could be caused by the identity theft or fraudulent activities related to the said victim;
the collecting of said information is accomplished through at least one or more organizations selected from the group consisting essentially of credit bureaus, the agents of credit bureaus which provide services by using the data from credit bureaus, the applicants who may need to go through credit checks to get some kind of approval, and merchants including retail stores, financial institutions, and government agencies;
the list of possible victims is sent to at least one participating organization, which compares the list with at least one database selected from the group consisting of a member database, a customer database, and an employee database;
the informing of said potential victim is accomplished at least through e-mail, fax, phone, or other communication methods;
said potential victim verifies the suspicious actives by logging into the computer system, calling a service center, visiting a service center in person, or using a self-service terminal;
once the potential victim has verified that the detected cases are fraudulent, the computer system will at least
report the case to credit bureaus, police departments, government agencies, financial institutions, and merchants including retail stores,
provide the victim with network links to credit bureaus, police departments, government agencies, non-profit organizations, commercial service providers, and law firms, and
provide action guidelines to the victim.

46. The method of claim 45, further comprising:
once the potential victim has determined that the detected cases are fraudulent, using a computer system to detect related cases, which can also be fraudulent activities, and thereby identify additional victims so that additional protective actions can also be taken to protect these additional victims.

47. The method of claim 46, further comprising:
using the computer system to identify trends and patterns.

48. The method of claim 46, further comprising:
using the computer system to identify statistical information.
